(19) United States
(12) Patent Application Publication
(10) Pub. No.: US 2008/0203242 A1
(43) Pub. Date: Aug. 28, 2008

(54) Spacer Assembly

(75) Inventor: Brian Buck, Jackson, TN (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Anvil International, LP

(21) Appl. No.: 12/037,390

(22) Filed: Feb. 26, 2008

Related U.S. Application Data
(60) Provisional application No. 60/891,700, filed on Feb. 26, 2007.

(51) Int. Cl. F16L 3/00

(52) U.S. Cl. 248/62

(57) ABSTRACT

Embodiments of the present invention are generally directed to improved clevis hangers and pipe claims and more particularly to spacer assemblies for use with clevis hangers and pipe claims. In one embodiment, a hanger assembly for supporting a pipe or conduit is provided. The hanger assembly includes an upper yoke having two substantially parallel spaced apart legs wherein each leg defines an aperture; a lower yoke configured to engage the pipe or conduit wherein the lower yoke includes two substantially parallel spaced apart arms wherein each arm defines an openings; a tie rod inserted through the apertures defined by the upper yoke and the openings defined by the lower yoke, wherein each leg of the upper yoke is positioned proximate an arm of the lower yoke; and a spacer assembly having a substantially C-shaped engagement portion secured to the tie rod at a position between the spaced apart arms of the lower yoke via a snap fit engagement wherein the spacer assembly includes a groove formed on an inner surface of the C-shaped engagement portion to facilitate the snap fit.

### CROSS-REFERENCE TO RELATED APPLICATIONS

This application claims the benefit of U.S. Provisional Application No. 60/891,700, entitled Spacer Assembly, filed Feb. 26, 2007, which is incorporated by reference herein in its entirety.

### BACKGROUND OF THE INVENTION

1. Field of the Invention

Embodiments of the present invention generally relate to clevis hangers and pipe clamps.

2. Description of Related Art

Conventional clevis hanger systems have long been used in the construction field and in oil, gas, and water distribution systems where floor or plant space is limited, thus requiring the elevated suspension of pipes and conduits. Typical clevis hangers include a hanger rod anchored to a ceiling or overhead of a structure and two yokes configured to support a pipe or conduit. One yoke is attached to the hanger rod proximate its midpoint and includes two downwardly directed and spaced apart legs. The second yoke is substantially U-shaped and is designed to support the pipe or conduit. The ends of the two yokes define apertures that are aligned to receive a tie rod therethrough. Under high downward load conditions or seismic events, the yokes have a tendency to deform such that the ends of the yokes move inward on the tie rod. Depending on the severity of the deformation, the clevis hanger can fail causing the pipe or conduit to fall. Similar deformation can occur when the pipe or conduit being supported has a diameter smaller than the diameter for which the clevis hanger is designed.

To address this deformation issue, spacers are often placed over the tie rod to impede the inward movement of the ends of the yokes. Various styles of spacers are currently available. One style spacer resembles a piece of pipe cut to length (i.e. a pipe sleeve) in which the tie rod is inserted. Although this style provides additional support to the yokes, it requires disassembly of the clevis hanger in order to install the spacer in existing applications thereby creating significant costs.

A second style is marketed by Tolco™ as a clevis bolt spacer. The clevis bolt spacer is an elongate device with a U-shaped cross-section. Notches are formed proximate the ends of the clevis bolt spacer to create tabs. These tabs are bent inward after placing the clevis bolt spacer on the tie rod to secure the clevis bolt spacer in place. A disadvantage of this design is that the notches and tabs reduce the buckling performance of the spacer and thus the resistance of the respective clevis hanger to damage in response to high downward loads and seismic events. Furthermore, the need to bend two tabs in order to install the spacer can be time consuming, especially if the particular application has limited clearance. Additionally, the clevis bolt spacers must be produced in a variety of different lengths to accommodate different sized clevis hangers (e.g., 1 inch to 20 inches in length). Another similar prior art spacer has a U-shaped cross-section but uses machine bolts to secure the spacer to the clevis hanger as opposed the tabs on the clevis bolt spacer.

A third known spacer style has a snap fit design. Due to the snap fit feature, different sizes must be used for different diameter tie rods. A potential safety concern with this style of spacer is that under some conditions, the conduit or pipe being supported by the clevis hanger may be forced upward into the spacer such as in response to a seismic event. If the opening of the snap fit spacer is facing toward the pipe or conduit when this occurs, the spacer may be forced off of the tie rod thereby making the clevis hanger vulnerable to deformation. Finally, because the part needs to be thin in order to facilitate the snap fit, buckling capacity is often sacrificed. Thus, a need exists for improved spacer designs that address deficiencies in the art.

### BRIEF SUMMARY OF THE INVENTION

The above and other needs are met by various embodiments of the present invention which, in one embodiment, provides a hanger assembly for supporting a pipe or conduit. The hanger assembly includes an upper yoke having two substantially parallel spaced apart legs, wherein each leg defines an aperture; a lower yoke configured to engage the pipe or conduit wherein the lower yoke includes two substantially parallel spaced apart arms, wherein each arm defines an opening; a tie rod inserted through the apertures defined by the upper yoke and the openings defined by the lower yoke, wherein each leg of the upper yoke is positioned proximate a respective arm of the lower yoke; and a spacer assembly having a substantially C-shaped engagement portion secured to the tie rod at a position between the spaced apart arms of the lower yoke via a snap fit engagement, wherein the spacer assembly includes a groove formed on an inner surface of the C-shaped engagement portion to facilitate the snap fit.

In a further embodiment, a hanger assembly for supporting a pipe or conduit is provided. The hanger assembly includes an upper yoke having two substantially parallel spaced apart legs, wherein each leg defines an aperture; a lower yoke configured to engage the pipe or conduit wherein the lower yoke includes two substantially parallel spaced apart arms, wherein each arm defines an openings; a tie rod inserted through the apertures defined by the upper yoke and the openings defined by the lower yoke, wherein each leg of the upper yoke is positioned proximate a respective arm of the lower yoke; and a spacer assembly having a first substantially C-shaped engagement portion configured to snap fittingly engage a rod having a first diameter, which is greater than the diameter of the tie rod, and a second substantially C-shaped engagement portion configured to snap fittingly engage a rod having a second diameter which greater than the diameter of the tie rod. The first substantially C-shaped engagement portion is positioned such that the inner surface of the first engagement portion engages the tie rod and the C-shape of the first engagement portion is deformed to secure the spacer assembly to the tie rod.

In another embodiment, a spacer assembly is provided. The spacer assembly has a substantially C-shaped engagement portion configured to snap fittingly engage a cylindrical rod having a diameter, wherein the spacer assembly includes a groove formed on an inner surface of the C-shaped engagement portion.

In a further embodiment, another spacer assembly is provided. The spacer assembly has a first C-shaped engagement portion configured engage a first cylindrical rod having a first diameter and a second engagement portion configured to engage a second cylindrical rod having a second diameter, wherein the first and second engagement portions include a groove formed on an inner surface of the respective C-shaped engagement portion and wherein a boss is formed on the outer surface of at least one of the first or second engagement portions.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a cross-sectional view of a clevis hanger system 50 comprising a clevis hanger 100, bracing assembly 150, and a spacer assembly 200 in accordance with an embodiment of the present invention.

FIG. 2 is cross-sectional view of a spacer assembly 200 in accordance with an embodiment of the present invention.

FIG. 3 is a cross-sectional view of a pipe clamp system 500 in accordance with an embodiment of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Generally described, various embodiments of the present invention provide an improved spacer assembly for use with clevis hangers and pipe clamps, which improve the structural integrity of the hangers or clamps. In various embodiments, the spacer assembly provides multiple engagement portions such that a single spacer assembly can be used with a variety of different sized hangers and clamps. The engagement portions may include a unique geometry that facilitates a “snap” fit engagement. Also, in various embodiments, the spacer assembly may include strategically placed bosses, which alter the center of gravity of the spacer assembly for improved performance. These bosses also increase the total cross-sectional area of the spacer, which may improve the buckling resistance of the spacer.

Embodiments of the present invention will now be described in relation to a clevis hanger type application. However, it should be understood that embodiments of the present invention may be used in any application in which there is a desire to maintain a particular spacing between two items joined by a rod or bolt, such as a pipe clamp.

Clevis Hanger 100

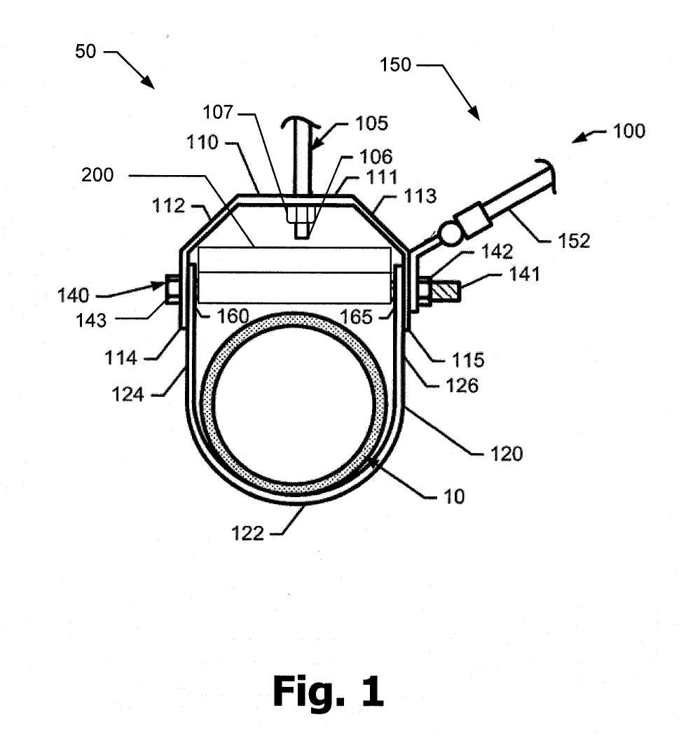

FIG. 1 illustrates a clevis hanger system 50 including a clevis hanger 100, a bracing assembly 150, and a spacer assembly 200. The clevis hanger 100 includes a hanger rod 105, a top yoke 110, a bottom yoke 120, and a tie rod 140.

The hanger rod 105 is an elongate member configured to support the clevis hanger 100 from a structure. An upper end (not shown) of the hanger rod 105 is anchored to a structure (not shown), such as the structure's ceiling or overhang as will be understood by those of skill in the art. An opposite lower end 106 of the hanger rod 105 may be threaded to receive a retention nut 107 to facilitate attachment of a top yoke 110 to the hanger rod 105.

The top yoke 110 includes a base section 111, which defines an aperture (not shown) proximate its midpoint that is configured to receive the threaded end 106 of the hanger rod 105. In use, the threaded end 106 of the hanger rod 105 is passed through the aperture defined by the base section 111. A retention nut 107 engages the threaded end 106 to secure the top yoke 110 to the hanger rod 105. As will be understood by those of skill in the art, a retention nut (not shown) may also be positioned along the hanger rod 105 at a location above the base section 111. Both the retention nut 107 below the base section 111 and the retention nut (not shown) above the base section 111 may be tightened against the base section 111 to secure the top yoke 110 to the hanger rod 105.

Extending outwardly and downwardly from base section 111 of the top yoke 110 are two substantially linear upper arms 112, 113. The linear upper arms 112, 113 terminate at respective leg portions 114, 115 that are substantially parallel to one another. Each of the leg portions 114, 115 define an aperture (not shown) proximate the end of the respective leg portion, where the apertures defined in the two leg portions 114,115 are in substantial alignment.

The bottom yoke 120 is substantially U-shaped with an arcuate bottom 122, and a pair of generally parallel arms 124, 126 extending upwardly from the arcuate bottom 122. Each of the parallel arms 124, 126 define an aperture (not shown) proximate the end of the respective arm such that the apertures in the parallel arms 124, 126 are in substantial alignment. The interior surface of the U-shaped bottom yoke 120 is configured to support the pipe or conduit 10.

In use, the apertures defined by the leg portions 114, 115 of the top yoke 110 are aligned with the apertures defined by the arms 124, 126 of the bottom yoke 120 and a tie rod 140 is inserted through the aligned apertures. The tie rod 140 is an elongate member having a rod portion 141 and a head portion 143. In various embodiments, the rod portion 141 is at least partially threaded proximate the end opposite the head portion 143. In use, the threaded portion of the tie rod 140 is engaged by a retention nut 142. In various embodiments, the tie rod 140 may be a threaded bolt, a threaded rod utilizing retention nuts on both ends, or a rod having thread sections on each end, which are engaged by retention nuts.

Bracing Assembly 150

To restrain non-vertical movement of the clevis hanger 100, a bracing assembly 150 may be attached to the clevis hanger 100. The bracing assembly 150 comprises a bracing rod 152 attached to the clevis hanger 100 via the tie rod 140 at one end. The opposite end (not shown) is attached to the structure. In a number of building codes, particularly those in earthquake or seismic prone locations, the use of the bracing assembly 150 for the purposes of stabilizing a clevis hanger system can be required. It should be understood that various embodiments of the present invention may not employ a bracing assembly 150.

Although the bracing assembly 150 can reduce non-vertical movement of the clevis hanger 100, transmission of non-vertical forces from the pipe or the bracing assembly 150 can distort the yokes 110 and 120. This may occur, for example, in the event of seismic tremor. Such distortions can result in the reduced functionality of the clevis hanger, which could result in release of the suspended conduit or pipe 10. In addition to the potential distortion, the bracing assembly 150 may pull on the tie rod 140 to an extent sufficient to deform one or both apertures of the yokes 110 and 120 causing the tie rod 140 to be released. Therefore, it may be advantageous to include spacer assemblies with clevis hangers employing bracing assemblies 150.

Spacer Assembly 200

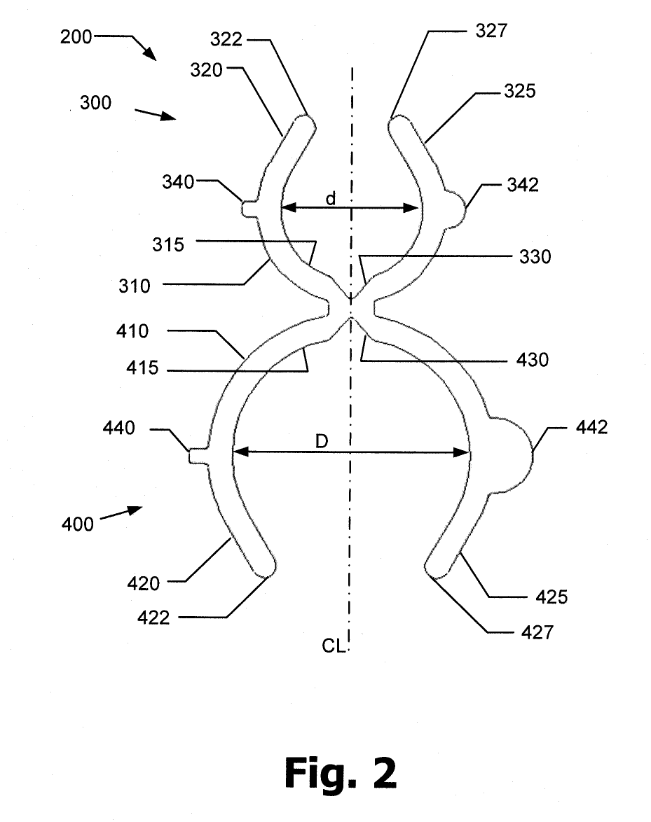

FIG. 2 illustrates the cross-section of an embodiment of the spacer assembly 200. The spacer assembly 200 includes a first engagement portion 300 and a second engagement portion 400. Although the spacer assembly 200 is illustrated with only two engagement portions, it should be understood that other embodiments may include a single engagement portion or more than two engagement portions.

The spacer assembly 200 is preferably manufactured of aluminum and formed using an extrusion process. However, other embodiments may be manufactured from other rigid materials such as steel or plastic. Furthermore, other processes may be used to manufacture the spacer assembly such as casting or other known processes.

In cross-section, the first engagement portion 300 is generally C-shaped. Various other embodiments may include linear sections as opposed to the general arcuate shape of the illustrated embodiment. The C-shape of the illustrated embodiment has a diameter “d” and defines an outer surface 310 and an inner surface 315. In the illustrated embodiment, the C-shape includes linear sections 320 and 325, which terminate at spaced apart ends 322, 327 respectively. Various other embodiments may not include linear sections and instead have a cross-section that is substantially arcuate with spaced apart ends. In the illustrated embodiment, the ends are rounded; however, in other embodiments, the ends may be flat.

The first engagement portion 300 is configured to flex such that the space between the ends 322, 327 increases during installation onto a tie rod such that the tie rod 140 may be captured by the engagement portion 300. The engagement portion geometry creates a “snap” effect to secure the spacer assembly 200 to a tie rod 140.

Proximate the midpoint of the C-shape is a triangular shaped groove 330 formed on the inner surface 315. In various other embodiments, the groove 330 may have a rectangular, trapezoidal, arcuate or other desired shape. This groove 330 may improve the flexibility of the engagement portion 300 to facilitate flexing of the C-shape and engagement of the tie rod 140.

A small boss 340 may be formed proximate the linear section 320 and a larger boss 342 formed proximate linear section 325. The difference in size of these bosses shifts the center of gravity of the spacer assembly 200 from the centerline “CL” of the two engagement portions. As a result, when installed, the spacer assembly 200 will have a tendency to rotate in response to gravitational forces such that the opening of the engagement portion engaging the tie rod 140 is facing away from the pipe or conduit being supported. As a result, the tendency of the spacer assembly 200 to disengage the tie rod 140 due to impact from the pipe or conduit being supported is reduced. It should be understood that various embodiments may have a single boss positioned anywhere on the outer surface 310 to alter the center of gravity of the spacer assembly 200. Also, the presence of a boss or bosses can promote proper positioning of pliers or similar instruments when a force needs to be applied to deform an engagement portion such that the ends are closer together for select installations, as will be discussed in greater detail later.

In cross-section, the second engagement portion 400 is generally C-shaped. Various other embodiments may include linear sections as opposed to the general arcuate shape of the illustrated embodiment. In various embodiments, the engagement portion 300 and engagement portion 400 may or may not have the same general cross-section. The C-shape of the engagement portion 400 in the illustrated embodiment has a diameter “D” and defines an outer surface 410 and an inner surface 415. The diameter “D” of the second engagement portion 400 is larger than the diameter “d” of the first engagement portion 300. This difference allows a single spacer assembly to accommodate different tie rod diameters. In the illustrated embodiment, the C-shape includes linear sections 420 and 425, which terminate at spaced apart ends 422,427, respectively. Various other embodiments may not include linear sections and instead have a cross-section that is substantially arcuate with spaced apart ends. In the illustrated embodiment, the ends are rounded; however, in other embodiments, the ends may be flat.

The second engagement portion 400 is configured to flex such that the space between the ends 422,427 increases during installation onto a tie rod 140 such that the tie rod 140 may be captured by the engagement portion 400. The engagement geometry creates a “snap” effect to secure the spacer assembly 200 to a tie road 140 as desired.

Proximate the midpoint of the C-shape is a triangular shaped groove 430 formed on the inner surface 415. In various other embodiments, the groove 430 may have a rectangular shape, trapezoidal, arcuate or other desired shape. This groove 430 may improve the flexibility of the engagement portion 400 to facilitate flexing of the C-shape and engagement of the tie rod 140.

As discussed above with respect to engagement portion 300, a small boss 440 may be formed proximate end portion 420 and a larger boss 442 formed proximate end portion 425 of engagement portion 400. The difference in size of these bosses shifts the center of gravity of the spacer assembly from the centerline “CL” of the two engagement portions. As a result, when installed, the spacer assembly 200 will have a tendency to rotate such that the opening of the engagement portion engaging the tie rod 140 is facing away from the pipe or conduit being supported. As a result, the tendency of the spacer assembly to disengage the tie rod assembly due to impact from the pipe or conduit being supported is reduced. It should be understood that various other embodiments may have a single boss positioned on an outer surface one engagement portion or any combination of bosses on an outer surface such that the center of gravity is shifted from the centerline of the two engagement portions. Various other embodiments may not include bosses.

The apex of the outer surface 310 of the first engagement portion 300 is connected to the apex of the outer surface 410 of the second engagement portion 400 such that the openings of the engagement portions are substantially aligned with the centerline “CL” but opening in opposite directions. In various other embodiments, the engagement portions 300, 400 may not be attached at the apex and the openings may not be aligned with the centerline “CL.” For example, the openings may be facing a direction substantially perpendicular to the centerline “CL” and facing the same side of the spacer assembly.

Returning to FIG. 1, the spacer assembly 200 has a length preferably substantially equal to the gap between the arms 124, 126 of the clevis hanger 100. In various embodiments, the ends of the spacer assembly 200 will contact the inner surfaces 160 and 165 of the respective arms 124, 126. One skilled in the art would appreciate that the length of the spacer assembly 200 can be dependent on the support system for which the spacer assembly 200 is preventing from potential collapse. In use, the spacer assembly 200 may be provided in standard lengths, where each length is designed for use with particular sized clevis hanger. Alternatively, the spacer assembly 200 may be sold in relatively long lengths (e.g., 2, 3, or 6 foot sections), which are cut to a desired length at the job site.

To install the spacer assembly 200, the spacer assembly 200 is positioned substantially parallel with the tie rod and between the arms 124, 126 of the yoke 120 with either the first engagement portion 300 or the second engagement portion 400 of the spacer assembly 200 positioned against the tie rod 140. A force is then applied to the spacer assembly 200 directed towards the tie rod 140 such that the ends of the engagement portion positioned against the tie rod 140 flex outwardly allowing the interior surface of the respective engagement portion to engage the tie rod 140. The ends of the respective engagement portion then flex back to substantially their originating pre-flex position thereby creating a “snap” effect and securing the spacer assembly 200 to the tie rod 140. This type of engagement may be referred to as a “snap fit.” A benefit of the illustrated embodiment is that the spacer assembly 200 can be installed on a tie rod 140 without disturbing the already functioning support system. Furthermore, this type of engagement facilitates efficient installation of new clevis hangers because the new clevis hangers do not have to be disassembled to install a spacer.

The selection of the first engagement portion 300 versus the second engagement portion 400 may be made based on the diameter of the tie rod 140. For example, the first engagement portion 300 may have ends spaced apart by approximately 0.30″ (7.62 mm) to facilitate a snap fit engagement onto a tie rod having a diameter between approximately 0.31″ (7.874 mm) and 0.375″ (0.525 mm). Similarly, the second engagement portion 400 may have ends spaced apart by 0.4″ (10.16 mm) to facilitate snap fit engagement onto a tie rod having a diameter between 0.41″ (10.414 mm) and 0.625″ (15.875 mm). These diameters are typical for 12″ (304.8 mm) clevis hangers and smaller. As illustrated in this example, embodiments of spacer assembly 200 may facilitate installation on many different tie rod diameters with one device. Of course, other embodiments of the present invention may include different end spacings covering different tie rod diameter ranges. Also, the ranges given above are purely exemplary, and the actual ranges may be greater.

In various embodiments, the engagement portion 300 may be positioned on a tie rod having a diameter smaller than the spacing between the ends 322,327. In this case, the engagement portion 300 may be deformed using a tool, such as pliers, after positioning the engagement portion 300 on the tie rod to secure the spacer assembly 200 to the tie rod. For example, the engagement portion 300 may have ends spaced apart approximately 0.30″ (7.63 mm). This engagement portion may be positioned onto a tie rod having a diameter of 0.25″ (6.35 mm). A pair of pliers could then be used to reduce the space between the ends such that the spacer assembly is secured to the tie rod. In other words, reduce the gap between the ends such that the gap is smaller than 0.25″ (6.35 mm)). In various embodiments, the groove 330 formed on the inner surface of the engagement portion 300 may reduce the force required to deform the engagement portion. Also, in various embodiments, bosses 340,342 formed on the outer surface of the engagement portion 300 may promote proper application of force to deform the engagement portion.

Once installed, the ends of the spacer assembly resist the inward movement of the legs 114, 116 of the top yoke 110 and arms 124, 126 of the bottom yoke 120 thus allowing the clevis hanger 100 to retain its shape in response to high downward loads or seismic events. The complex cross-section geometry of the spacer assembly 200 is relatively large as compared to prior art designs and therefore should provide improved buckling performance.

Another beneficial feature of the spacer assembly 200 is, unlike conventional spacers, such as the pipe sleeve and the clevis bolt spacer, the spacer assembly can be easily removed from the tie rod, should it be so desired. If removed, the spacer assembly 200 can be reused in another support system. If the pipe sleeve were to be removed, however the entire support system must be disassembled. Removing the clevis bolt spacer while likely possible, would be laborious and may compromise the integrity of the clevis bolt spacer due to the additional inelastic bending required.

Pipe Clamp System 500

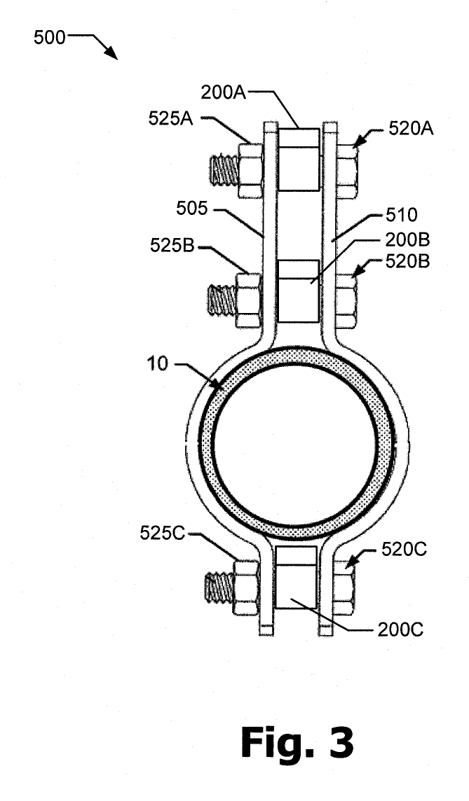

In FIG. 3, another support system for pipes and conduits is shown. The pipe clamp system 500 includes two clamp members 505 and 510 that are adapted to be placed on opposite sides of a pipe or conduit 10 to be supported. The two clamp members 505, 510 are fastened to one another via several fasteners 520A,B,C that extend through aligned openings (not shown) in the clamp members 505,510 and associated retention nuts 525A,B,C with the pipe or conduit 10 positioned therebetween. Similar to the clevis hanger 100, spacer assemblies 200A,B,C may be snap fit onto the fasteners 520A,B,C at a position between the clamping members 505, 510. Although the illustrated embodiment shows a pipe clamp system with three fasteners, other pipe clamp systems may include more or less fasteners. Furthermore, various embodiments may include spacer assemblies on less than all of the fasteners in the pipe clamp. For example, a three fastener pipe clamp assembly may only include a single spacer assembly 200 positioned on a single bolt (e.g., 520B).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A hanger assembly for supporting a pipe or conduit comprising:
an upper yoke having two substantially parallel spaced apart legs, wherein each leg defines an aperture;
a lower yoke configured to engage the pipe or conduit wherein the lower yoke includes two substantially parallel spaced apart arms, wherein each arm defines an opening;
a tie rod inserted through the apertures defined by the upper yoke and the openings defined by the lower yoke, wherein each leg of the upper yoke is positioned proximate a respective arm of the lower yoke; and
a spacer assembly having a substantially C-shaped engagement portion secured to the tie rod at a position between the spaced apart arms of the lower yoke via a snap fit engagement, wherein the spacer assembly includes a groove formed on an inner surface of the C-shaped engagement portion to facilitate the snap fit.

2. The hanger assembly of claim 1, wherein the spacer assembly includes a second C-shaped engagement portion configured to engage a rod having a different diameter than the diameter of the tie rod, wherein the second C-shaped engagement portion opens in a direction different from the direction in which the engagement portion configured to engage the tie rod opens.

3. The hanger assembly of claim 1, wherein the spacer assembly includes boss formed on one side of the C-shaped engagement portion such that the center of gravity of the spacer assembly is not aligned with the centerline of the C-shaped engagement portion.

4. The hanger assembly of claim 3, wherein the opposite side of the C-Shaped engagement portion include a different sized boss.

5. The hanger assembly of claim 2, wherein the engagement portion is configured to engage a tie rod having a diameter between approximately 0.31″ (7.874 mm) and 0.375″ (0.525 mm) and the second engagement portion is configured to engage a tie rod having a diameter between approximately 0.41″ (10.414 mm) and 0.625″ (15.875 mm).

6. The hanger assembly of claim 1, wherein in the groove has a substantially triangular shape.

7. A hanger assembly for supporting a pipe or conduit comprising:
an upper yoke having two substantially parallel spaced apart legs, wherein each leg defines an aperture;
a lower yoke configured to engage the pipe or conduit wherein the lower yoke includes two substantially parallel spaced apart arms, wherein each arm defines an openings;
a tie rod inserted through the apertures defined by the upper yoke and the openings defined by the lower yoke, wherein each leg of the upper yoke is positioned proximate a respective arm of the lower yoke; and
a spacer assembly having a first substantially C-shaped engagement portion configured to snap fittingly engage a rod having a first diameter, which is greater than the diameter of the tie rod, and a second substantially C-shaped engagement portion configured to snap fittingly engage a rod having a second diameter which is greater than the diameter of the tie rod,
wherein the first substantially C-shaped engagement portion is positioned such that the inner surface of the first engagement portion engages the tie rod and the C-shape of the first engagement portion is deformed to secure the spacer assembly to the tie rod.

8. A spacer assembly having a substantially C-shaped engagement portion configured to snap fittingly engage a cylindrical rod having a diameter, wherein the spacer assembly includes a groove formed on an inner surface of the C-shaped engagement portion.

9. The spacer assembly of claim 8, wherein the spacer assembly includes a second C-shaped engagement portion configured to snap fittingly engage a different cylindrical rod having a second diameter.

10. The spacer assembly of claim 8, wherein the spacer assembly includes boss formed on one side of the C-shaped engagement portion such that the center of gravity of the spacer assembly is not aligned with the centerline of the C-shaped engagement portion.

11. The spacer assembly of claim 10, wherein the opposite side of the C-Shaped engagement portion includes a different smaller boss.

12. The spacer assembly of claim 9, wherein the engagement portion is configured to engage a tie rod having a diameter between approximately 0.31″ (7.874 mm) and 0.375″ (0.525 mm) and the second engagement portion is configured to engage a tie rod having a diameter between approximately 0.41″ (10.414 mm) and 0.625″ (15.875 mm).

13. The spacer assembly of claim 8, wherein in the groove has a substantially triangular shape.

14. The spacer assembly of claim 8, wherein the spacer assembly has a substantially consistent cross-section over its entire length.

15. A spacer assembly having a first C-shaped engagement portion configured engage a first cylindrical rod having a first diameter and a second engagement portion configured to engage a second cylindrical rod having a second diameter wherein the first and second engagement portions include a groove formed on an inner surface of the respective C-shaped engagement portion and wherein a boss is formed on the outer surface of at least one of the first or second engagement portions.
